(19) United States
(12) Patent Application Publication
(10) Pub. No.: US 2020/0388242 A1
(43) Pub. Date: Dec. 10, 2020

(54) TIMING CONTROLLER DEVICE AND DATA READING-WRITING METHOD

(71) Applicant: Novatek Microelectronics Corp., Hsinchu (TW)

(72) Inventors: Hua-Gang Chang, Hsinchu County (TW); Cheng-Hao Lin, Hsinchu City (TW)

(73) Assignee: Novatek Microelectronics Corp., Hsinchu (TW)

(21) Appl. No.: 16/431,743

(22) Filed: Jun. 5, 2019

(51) Int. Cl. G09G 5/00; G09G 3/20

(52) U.S. Cl. CPC G09G 5/008; G09G 2300/0842; G09G 2330/027; G09G 3/20

(57) ABSTRACT

A timing controller device disposed in an electronic device is provided. The timing controller device includes a non-volatile memory and a timing controller. The non-volatile memory includes a plurality of storage blocks. The timing controller is coupled to the plurality of storage blocks. The timing controller writes the latest data to one of the plurality of storage blocks by turns according to a recording period. After the electronic device is powered off, the timing controller reloads the latest data stored in the plurality of storage blocks. In addition, a data reading-writing method is also provided.

### BACKGROUND OF THE INVENTION

### 1. Field of the Invention

The invention relates to a display driving device and a data reading-writing method, and particularly relates to a timing controller device and a data reading-writing method.

### 2. Description of Related Art

In display technologies, a display driver controls a gate driving circuit and a source driving circuit through a timing controller (TCON) to respectively provide signals to gate lines and data lines on an array substrate, so as to display an image. In addition, the display driver also keeps writing data that are calculated and detected to a memory through the timing controller, so that when an electronic device (e.g., a TV, a computer, or a cell phone, etc.) is turned off, the latest data may be stored in the memory to prevent data from being lost due to power failure.

However, when a power cut occurs or a battery is detached from the electronic device, the electronic device may encounter exceptional power failure while being used. In such case, the recorded data may be lost and result in a temporary or permanent abnormal frame when the electronic device is rebooted. Therefore, how to prevent frame data from being lost after the electronic device is powered off has become an issue for researchers of this field to work on.

### SUMMARY OF THE INVENTION

The invention provides a timing controller device and a data reading-writing method capable of preventing an electronic device from losing frame data after exceptional power failure occurs.

A timing controller device according to an embodiment of the invention is disposed in an electronic device. The timing controller device includes a non-volatile memory including a plurality of storage blocks and a timing controller coupled to the plurality of storage blocks. The timing controller writes latest data to one of the plurality of storage blocks by turns according to a recording period, and after the electronic device is powered off, the timing controller reloads the latest data stored in the plurality of storage blocks.

According to an embodiment of the invention, after writing the latest data to a storage block of the plurality of storage blocks, the timing controller indicates the storage block with a flag, and after the electronic device is powered off, the timing controller reloads data in the storage block indicated with the flag.

According to an embodiment of the invention, after writing the latest data to the storage block, the timing controller compares the latest data with the data of the storage block, and if a comparison result indicates that the latest data and the data of the storage block are the same, the timing controller indicates the storage block with the flag.

According to an embodiment of the invention, if the comparison result indicates that the latest data and the data of the storage block are different, the timing controller keeps writing the latest data to the storage block.

According to an embodiment of the invention, the timing controller keeps comparing the latest data with the data of the storage block, and if the comparison result keeps indicating that the latest data and the data of the storage block are different for a predetermined number of times, the timing controller writes the latest data to a next storage block according to the recording period.

According to an embodiment of the invention, if the electronic device encounters power failure when the timing controller writes the latest data to the storage block, the comparison result indicates that the latest data and the data of the storage block are different.

According to an embodiment of the invention, the timing controller compares the latest data with the data of the storage block through a cyclic redundancy check or a checksum.

According to an embodiment of the invention, the non-volatile memory is a flash memory.

A data reading-writing method according to an embodiment of the invention is adapted for a timing controller device. The timing controller device is disposed in an electronic device. The data reading-writing method includes: writing latest data to one of a plurality of storage blocks of a non-volatile memory by turns according to a recording period; and reloading the latest data stored in the plurality of storage blocks after the electronic device is powered off.

According to an embodiment of the invention, a storage block of the plurality of storage blocks is indicated with a flag after the latest data is written to the storage block, and data in the storage block indicated with the flag is reloaded after the electronic device is powered off.

According to an embodiment of the invention, the latest data and the data of the storage block are compared after the latest data is written to the storage block, and if a comparison result indicates that the latest data and the data of the storage block are the same, the storage block is indicated with the flag.

According to an embodiment of the invention, if the comparison result indicates that the latest data and the data of the storage block are different, the latest data keeps being written to the storage block according to the recording period.

According to an embodiment of the invention, the latest data and the data of the storage block keep being compared, and if the comparison result keeps indicating that the latest data and the data of the storage block are different for a predetermined number of times, the latest data is written to a next storage block according to the recording period.

According to an embodiment of the invention, if the electronic device encounters power failure when the latest data is written to the storage block, the comparison result indicates that the latest data and the data of the storage block are different.

According to an embodiment of the invention, the latest data and the data of the storage block are compared through a cyclic redundancy check or a checksum.

According to an embodiment of the invention, the non-volatile memory is a flash memory.

Based on the above, the embodiments of the invention provides the timing controller device and the data reading-writing method capable of preventing the electronic device from losing frame data after exceptional power failure by storing the latest data to one of the plurality of storage blocks by turns.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an electronic device according to an embodiment of the invention.

FIG. 2 is a block diagram of a timing controller device according to an embodiment of the invention.

FIG. 3 is a flowchart of a data reading-writing method of a timing controller device according to an embodiment of the invention.

FIG. 4 is a view showing an example of a data writing method of a timing controller device according to an embodiment of the invention.

FIGS. 5A and 5B are views illustrating actual operations of a data reading-writing method of a timing controller device according to an embodiment of the invention.

FIGS. 6A, 6B, 6C, 6D, 6E, and 6F are views illustrating actual operations of a data reading-writing method of a timing controller device according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The embodiments of the invention at least have one of the following advantages or effects. In a timing controller device and a data reading-writing method according to the embodiments of the invention, a non-volatile memory is divided into a plurality of storage blocks, and latest data is written into one of the plurality of storage blocks by turns according to a recording period by using a timing controller. Therefore, when an electronic device encounters exceptional power failure during a writing process performed by the timing controller, the non-volatile memory still stores the data written in the previous period. Besides, when the electronic device is rebooted, the timing controller may reload the data written in the previous period. In this way, the electronic device may be prevented from losing frame data after encountering the exceptional power failure.

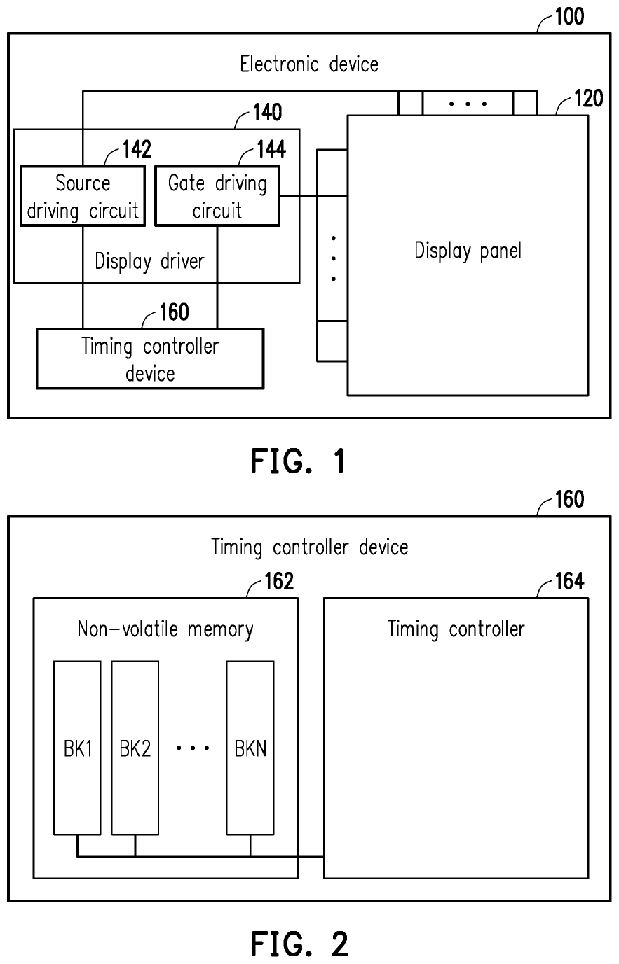

FIG. 1 is a block diagram of an electronic device according to an embodiment of the invention.

Referring to FIG. 1, an electronic device 100 of the embodiment includes a display panel 120, a display driver 140, and a timing controller device 160. The electronic device 100 may be, for example, an electronic device having a display, such as a TV, a cell phone, a personal digital assistant (PDA), or a laptop computer, etc.

However, the invention is not limited thereto. The display panel 120 has a plurality of pixels arranged in an array. The display panel 120 is, for example, a liquid crystal display panel, a plasma display panel, an organic electroluminescent display panel, an inorganic electroluminescent display panel, a vacuum fluorescent display panel, a field emission display panel, or an electro-chromic display panel, etc. However, the invention is not limited thereto. The display driver 140 is coupled to the display panel 120, and includes a source driving circuit 142 and a gate driving circuit 144. The timing controller device 160 is coupled to the source driving circuit 142 and the gate driving circuit 144.

Specifically, the timing controller device 160 provides a clock control signal to the source driving circuit 142 and the gate driving circuit 144, so as to control the source driving circuit 142 to provide a source driving signal to the display panel 120 and control the gate driving circuit 144 to provide a gate driving signal to the display panel 120. In this way, the display driver 140 may drive the display panel 120 to display a desired image frame.

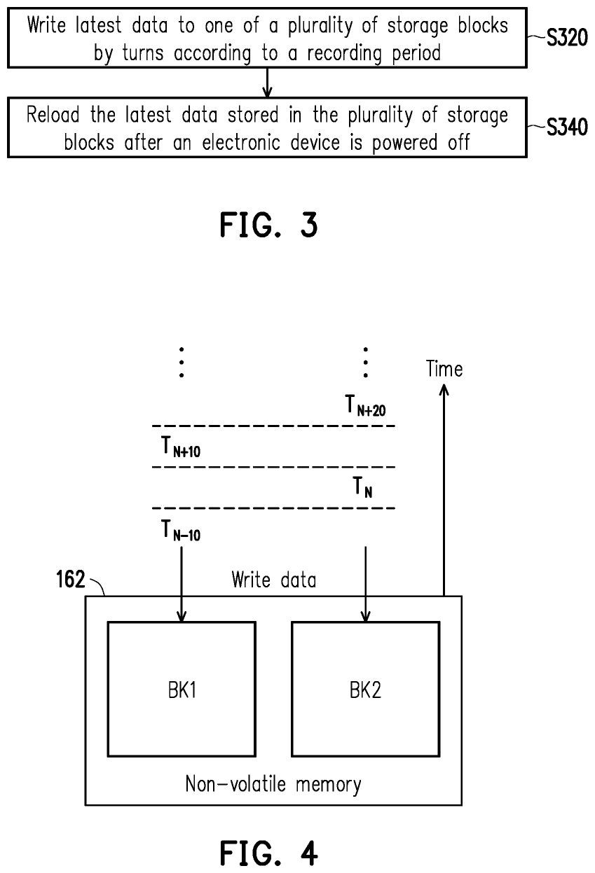

FIG. 2 is a block diagram of a timing controller device according to an embodiment of the invention.

Referring to FIG. 2, the timing controller device 160 of the embodiment includes a non-volatile memory 162 and a timing controller 164. The non-volatile memory 162 is a flash memory, for example, and may be substantially divided into a plurality of storage blocks BK1, BK2, . . . , BKN or be composed of the single storage block BK1. The invention does not intend to impose a limitation on this regard. The timing controller 164 is coupled to the storage blocks BK1, BK2, . . . , BKN.

Specifically, the non-volatile memory 162 is configured to store frame data received by the timing controller 164. The timing controller 164 sets a recording period, and in each recording period, the timing controller 164 receives latest frame data from the display panel 120 and writes the latest frame data to the non-volatile memory 162. Besides, during rebooting, the timing controller 164 may reload the latest frame data from the non-volatile memory 162, so that the display panel 120 may display the latest image frame.

In an embodiment, the non-volatile memory 162 in the timing controller device 160 includes only the single storage block BK1. In each recording period, the timing controller 164 writes the latest frame data from the display panel 120 to the storage block BK1 of the non-volatile memory 162. In this way, after the electronic device 100 encounters exceptional power failure, the timing controller 164 may read the latest data written at the previous recording time point from the storage block BK1 of the non-volatile memory 162, instead of reading data stored last time when the electronic device 100 is turned off, so as to reduce the influence of the exceptional power failure on the image frame.

Regular recording certainly helps restore the image frame to the latest recorded state after the electronic device 100 encounters the exceptional power failure and thus alleviates the situation of the abnormal frame. However, since the timing controller 164 needs to clear all the data in the storage block BK1 before writing the latest frame data to the storage block BK1 in order to write the latest frame data, if the power failure occurs at the moment when the electronic device 100 is performing the recording, some data in the storage block BK1 of the non-volatile memory 162 may become “0”, which causes an even more severe data loss.

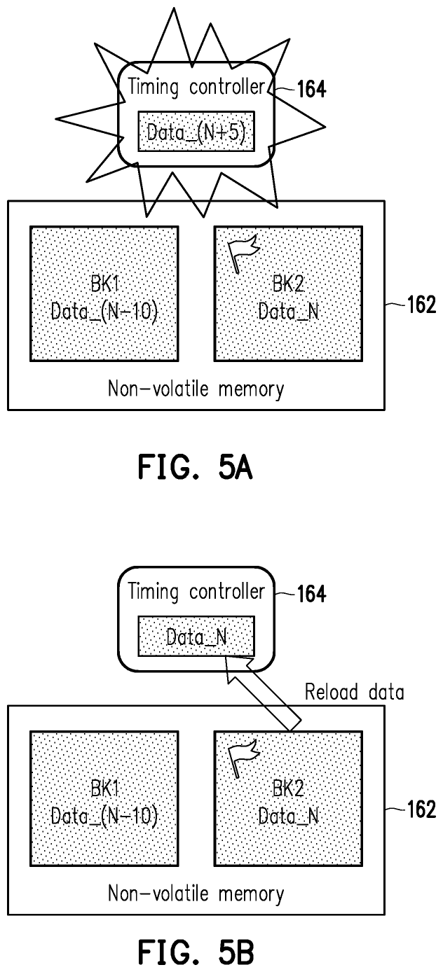

To solve the situation in which the electronic device encounters power failure at the moment of performing the recording, in an embodiment, the non-volatile memory 162 includes the storage blocks BK1, BK2, . . . , BKN, and the timing controller 164 executes the data reading-writing method shown in FIG. 3.

FIG. 3 is a flowchart of a data reading-writing method of a timing controller device according to an embodiment of the invention. Referring to FIGS. 2 and 3, the data reading-writing method of the embodiment is suitable for the timing controller device 160 shown in FIG. 2.

In Step S320, the timing controller 164 writes the latest data to one of the plurality of storage blocks BK1, BK2, . . . , BKN by turns according to a recording period. The recording period may be, for example, 10 minutes, one hour, etc. The invention does not intend to impose a limitation on this regard. Specifically, the timing controller 164 regularly updates the latest frame data at a predetermined time interval (e.g., 10 minutes, one hour, etc.), and writes the latest frame data to one of the plurality of storage blocks BK1, BK2, . . . , BKN by turns. In other words, the timing controller 164 may write the latest frame data to the storage block BK1 this time, and write the latest frame data to the storage block BK2 (or a storage block other than the storage block BK1) the next time.

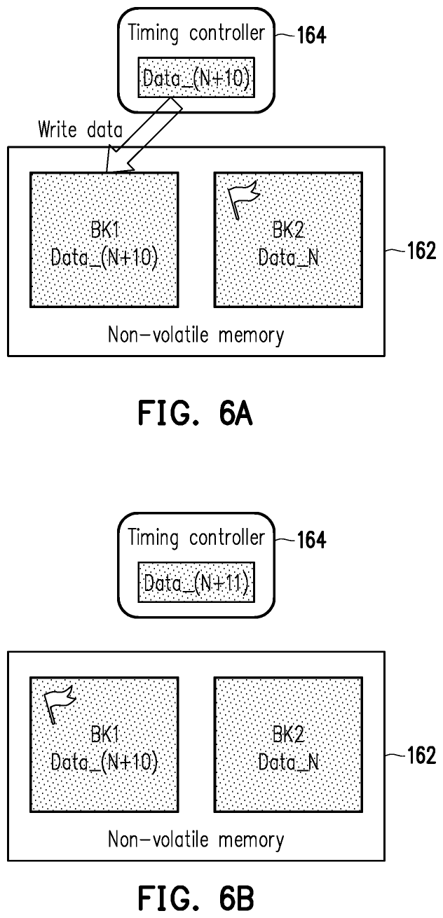

For example, FIG. 4 is a view showing an example of a data writing method of a timing controller device according to an embodiment of the invention. Referring to FIG. 4, the non-volatile memory 162 of the timing controller device 160 of the embodiment includes the storage block BK1 and the storage block BK2, and the timing controller 164 sets the recording period to be T₁₀. Under the condition, the timing controller 164 writes the frame data of time T_{N-10} to the storage block BK1, writes the frame data of time T_{N} to the storage block BK2, writes the frame data of time T_{N+10} to the storage block BK1, writes the frame data of time T_{N+20} to the storage block BK2, and so on so forth. The process is to write the latest frame data to the storage block BK1 and the storage block BK2 by turns. In the embodiment, N is a positive integer greater than or equal to 10.

In Step S340, after the electronic device 100 is powered off, the timing controller 164 reloads the latest data stored in the plurality of storage blocks BK1, BK2, . . . , BKN. Specifically, regardless of whether the electronic device 100 encounters exceptional power failure between recording periods or at the moment of recording, the least favorable situation is only that the timing controller 164 reloads the data written in the previous period. Therefore, the timing controller 164 is prevented from reloading the data stored the last time when the electronic device 100 is turned off normally or reloading data “0”.

In an embodiment, in Step S320, after the timing controller 164 writes the latest data to one of the plurality of storage blocks BK1, BK2, . . . , BKN, the timing controller 164 may indicate the storage block that is written with a flag. In addition, at Step S340, after the electronic device 100 is powered off, the timing controller 164 reloads the data in the storage block indicated with the flag.

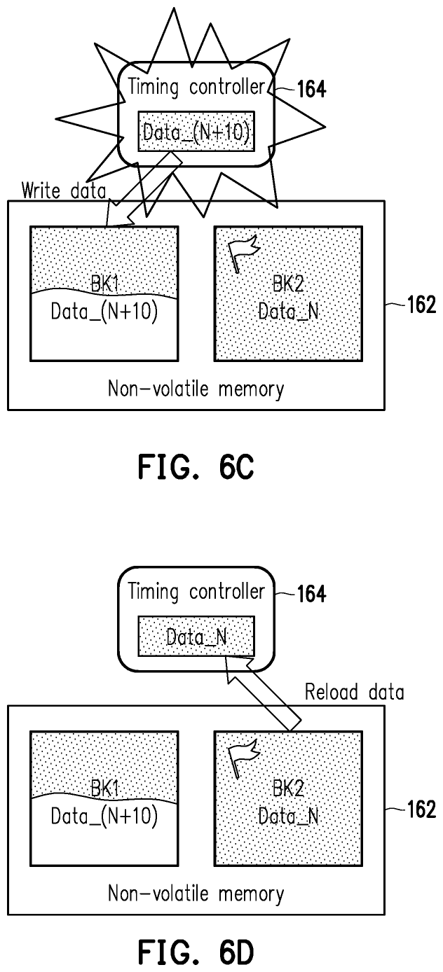

For example, FIGS. 5A and 5B are views illustrating actual operations of a data reading-writing method of a timing controller device according to an embodiment of the invention. In the embodiment, the non-volatile memory 162 includes the storage block BK1 and the storage block BK2, and the timing controller 164 sets the recording period to be T₁₀. It should be noted that, in the embodiment, at the time T_{N}, the latest frame data received by the timing controller 164 is Data_N, at the time T_{N+10}, the latest frame data received by the timing controller 164 is Data_(N+10), and so on so forth, but the reference symbols used herein merely serve to name different frame data received at different time points, and shall not be construed as a limitation on the invention. In the embodiment, N is a positive integer greater than or equal to 10.

Referring to FIGS. 5A and 5B, at the time T_{N-10}, the timing controller 164 writes data Data_(N−10) to the storage block BK1, and indicates the storage block BK1 with the flag. Then, at the time T_{N}, the timing controller 164 writes the data Data_N to the storage block BK2, and indicates the storage block BK2 with the flag.

FIG. 5A shows that, at time T_{N+5}, the timing controller 164 receives frame data Data_(N+5), and at this time, the electronic device 100 suddenly encounters exceptional power failure. Then, FIG. 5B shows that, at time T_{N+6}, when the electronic device 100 is rebooted, the timing controller 164 reloads the data Data_N in the storage block BK2 indicated with the flag.

In another embodiment, in Step S320, after the timing controller 164 writes the latest data to one of the plurality of storage blocks BK1, BK2, . . . , BKN, the timing controller 164 may compare the latest data with the data of the storage block that is written. In particular, in an embodiment, the timing controller 164 compares the latest data with the data of the written storage block through a cyclic redundancy check and a checksum. If a comparison result indicates that the latest data and the data of the written storage block are the same, the timing controller 164 may indicate the written storage block with the flag. If the comparison indicates that the latest data and the data of the written storage block are different, the timing controller 164 still keeps writing the latest data to the storage block that is previously written according to the recording period. In addition, at Step S340, after the electronic device 100 is powered off, the timing controller 164 reloads the data in the storage block indicated with the flag.

It should be noted that, in the embodiment, the timing controller 164 keeps comparing the latest data with the data of the written storage block. If the comparison result keeps indicating that the latest data and the data of the written storage block are different for a predetermined number of times, the timing controller 164 may write the latest data to the next storage block according to the recording period. Specifically, after writing the latest data to the storage block BK1, the timing controller 164 compares the latest data with the data of the storage block BK1. Since the comparison result indicates that the latest data and the data of the storage block BK1 are different, in the next recording period, the timing controller 164 still writes the latest data to the storage block BK1. If the comparison result keeps indicating that the latest data and the data of the storage block BK1 are different after M consecutive recording periods, the storage block BK1 may have been permanently damaged. Therefore, the timing controller 164 may write the latest data to the storage block BK2 or a storage block other than the storage block BK1 (i.e., the next storage block). In the embodiment, M is a positive integer greater than or equal to 2.

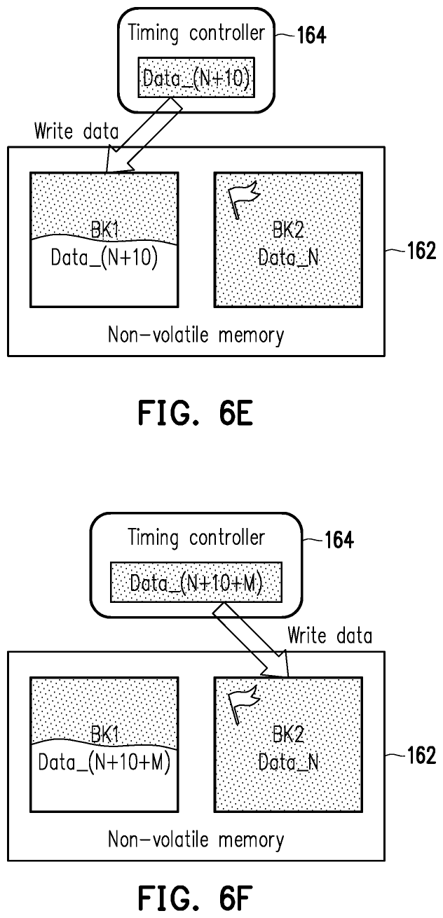

For example, FIGS. 6A, 6B, 6C, 6D, 6E, and 6F are views illustrating actual operations of a data reading-writing method of a timing controller device according to an embodiment of the invention. In the embodiment, the non-volatile memory 162 includes the storage block BK1 and the storage block BK2, and the timing controller 164 sets the recording period to be T₁₀. It should be noted that, in the embodiment, at the time T_{N}, the latest frame data received by the timing controller 164 is the Data_N, at the time T_{N+1}, the latest frame data received by the timing controller 164 is the Data_(N+10), and so on so forth, but the reference symbols used herein merely serve to name different frame data received at different time points, and shall not be construed as a limitation on the invention. In the embodiment, N is a positive integer greater than or equal to 10.

Referring to FIGS. 6A and 6B, at the time T_{N}, after writing the data Data_N to the storage block BK2, the timing controller 164 compares the data Data_N with the data of the storage block BK2. Since the comparison result indicates that the data Data_N and the data of the storage block BK2 are the same, the timing controller 164 indicates the storage block BK2 with the flag. Then, at the time T_{N+10}, after writing the data Data_(N+10) to the storage block BK1, the timing controller 164 compares the data Data_(N+10) with the data of the storage block BK1. Since the comparison result indicates that the data Data_(N+10) and the data of the storage block BK1 are the same, the timing controller 164 indicates the storage block BK1 with the flag.

FIG. 6A shows that, at the time T_{N+10}, the timing controller 164 successfully writes the latest data Data_(N+10) to the storage block BK1. Then, FIG. 6B shows that, at the time T_{N+11}, the flag indicates the storage block BK1.

Referring to FIGS. 6C and 6D, what differs from FIGS. 6A and 6B is that the electronic device 100 of FIGS. 6C and 6D suddenly encounters exceptional power failure at the time T_{N+10} (i.e., the moment when the timing controller 164 writes the data Data_(N+10) to the storage block BK1), so some of the data in the storage block BK1 is “0”. At this time, the timing controller 164 compares the data Data_(N+10) with the data of the storage block BK1. Since the comparison result indicates that the data Data_(N+10) and the data of the storage block BK1 are different, the flag still indicates the storage block BK2. Therefore, when the electronic device 100 is rebooted, the timing controller 164 reloads the data Data_N in the storage block BK2 indicated with the flag.

FIG. 6C shows that, at the time T_{N+10}, the timing controller 164 writes the latest data Data_(N+10) to the writing block BK1, and the electronic device 100 encounters the exceptional power failure at this time. Then, FIG. 6D shows that, at the time T_{N+11}, when the electronic device 100 is rebooted, the timing controller 164 reloads the data Data_N in the storage block BK2 indicated with the flag.

Referring to FIGS. 6E and 6F, at the time T_{N}, after writing the data Data_N to the storage block BK2, the timing controller 164 compares the latest data with the data of the storage block BK2. Since the comparison result indicates that the latest data and the data of the storage block BK2 are the same, the timing controller 164 indicates the storage block BK2 with the flag. Then, at the time T_{N+10}, after writing the data Data_(N+10) to the storage block BK1, the timing controller 164 compares the data Data_(N+10) with the data of the storage block BK1. Since the comparison result indicates that the data Data_(N+10) and the data of the storage block BK1 are different, the flag still indicates the storage block BK2. Afterwards, the timing controller 164 writes the latest frame data to the storage block BK1 according to the recording period T₁. In other words, at time T_{N+11}, the timing controller 164 writes latest data Data_(N+11) to the storage block BK1 and compares the data Data_(N+11) with the data of the storage block BK1. When the timing controller 164 keeps writing the latest data to the storage block BK1 according to the recording period T₁, and the comparison result keeps indicating that the latest data and the data of the storage block BK1 are different for M consecutive times, the timing controller 164 may write the latest data to the storage block BK2 instead. In other words, at time T_{N+10+M}, the timing controller 164 also writes latest data Data_(N+10+M) to the storage block BK1 and compares the data Data_(N+10+M) with the data of the storage block BK1, and the comparison result still indicates that the data Data_(N+10+M) and the data of the storage block BK1 are different. Then, the timing controller 164 may write latest data Data_(N+10+M) to the storage block BK2. At this time, the flag still indicates the storage block BK2. It should be noted that, in another embodiment, the recording period T₁ may also be T₅ or T₁₀, etc. However, the invention is not limited thereto.

FIG. 6E shows that, at the time T_{N+10}, the timing controller 164 writes the latest data Data_(N+10) to the storage block BK1, but does not successfully carry out the writing. FIG. 6F shows that, after the time T_{N+10}, the timing controller 164 writes the latest frame data to the storage block BK1 according to the recording period T₁, and the latest data has not been successfully written to the storage block BK1 for M consecutive times. Then, at the time T_{N+10+M}, the timing controller 164 writes the latest data Data_(N+10+M) to the storage block BK2 to cope with the situation that the storage block BK1 may have been permanently damaged.

In view of the foregoing, in the embodiments of the invention, since the non-volatile memory includes the plurality of storage blocks, the timing controller may regularly store the latest frame data to one of the plurality of storage blocks by turns at a fixed time interval. The data reading-writing method of the embodiment is described with an example having two storage blocks. However, the invention is not limited thereto. The timing controller firstly writes the latest data to the first storage block. Then, after the fixed time interval passes, the timing controller writes the latest data to the second storage block. The latest frame data keeps being regularly written to the first storage block and the second storage block by turns at the fixed time interval. Therefore, when the electronic device encounters exceptional power failure during a writing process of the timing controller, the non-volatile memory still stores the data written in the previous period. Besides, when the electronic device is rebooted, the timing controller may reload the data written in the previous period. In this way, the timing controller according to the embodiments of the invention can prevent the electronic device from losing frame data after encountering exceptional power failure.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A timing controller device, disposed in an electronic device and comprising:
a non-volatile memory, comprising a plurality of storage blocks; and
a timing controller, coupled to the plurality of storage blocks,
wherein the timing controller writes latest data to one of the plurality of storage blocks by turns according to a recording period, and after the electronic device is powered off, the timing controller reloads the latest data stored in the plurality of storage blocks.

2. The timing controller device as claimed in claim 1, wherein after writing the latest data to a storage block of the plurality of storage blocks, the timing controller indicates the storage block with a flag, and after the electronic device is powered off, the timing controller reloads data in the storage block indicated with the flag.

3. The timing controller device as claimed in claim 2, wherein after writing the latest data to the storage block, the timing controller compares the latest data with the data of the storage block, and if a comparison result indicates that the latest data and the data of the storage block are the same, the timing controller indicates the storage block with the flag.

4. The timing controller device as claimed in claim 3, wherein if the comparison result indicates that the latest data and the data of the storage block are different, the timing controller keeps writing the latest data to the storage block according to the recording period.

5. The timing controller device as claimed in claim 4, wherein the timing controller keeps comparing the latest data with the data of the storage block, and if the comparison result keeps indicating that the latest data and the data of the storage block are different for a predetermined number of times, the timing controller writes the latest data to a next storage block according to the recording period.

6. The timing controller device as claimed in claim 4, wherein if the electronic device encounters power failure when the timing controller writes the latest data to the storage block, the comparison result indicates that the latest data and the data of the storage block are different.

7. The timing controller device as claimed in claim 3, wherein the timing controller compares the latest data with the data of the storage block through a cyclic redundancy check or a checksum.

8. The timing controller device as claimed in claim 1, wherein the non-volatile memory is a flash memory.

9. A data reading-writing method, adapted for a timing controller device, wherein the timing controller device is disposed in an electronic device, and the data reading-writing method comprises:
writing latest data to one of a plurality of storage blocks of a non-volatile memory by turns according to a recording period; and
reloading the latest data stored in the plurality of storage blocks after the electronic device is powered off.

10. The data reading-writing method as claimed in claim 9, wherein a storage block of the plurality of storage blocks is indicated with a flag after the latest data is written to the storage block, and data in the storage block indicated with the flag is reloaded after the electronic device is powered off.

11. The data reading-writing method as claimed in claim 10, wherein the latest data and the data of the storage block are compared after the latest data is written to the storage block, and if a comparison result indicates that the latest data and the data of the storage block are the same, the storage block is indicated with the flag.

12. The data reading-writing method as claimed in claim 11, wherein if the comparison result indicates that the latest data and the data of the storage block are different, the latest data keeps being written to the storage block according to the recording period.

13. The data reading-writing method as claimed in claim 12, wherein the latest data and the data of the storage block keep being compared, and if the comparison result keeps indicating that the latest data and the data of the storage block are different for a predetermined number of times, the latest data is written to a next storage block according to the recording period.

14. The data reading-writing method as claimed in claim 12, wherein if the electronic device encounters power failure when the latest data is written to the storage block, the comparison result indicates that the latest data and the data of the storage block are different.

15. The data reading-writing method as claimed in claim 11, wherein the latest data and the data of the storage block are compared through a cyclic redundancy check or a checksum.

16. The data reading-writing method as claimed in claim 9, wherein the non-volatile memory is a flash memory.
